(19) United States
(12) Patent Application Publication
(10) Pub. No.: US 2018/0275957 A1
(43) Pub. Date: Sep. 27, 2018

(54) ASSISTIVE TECHNOLOGY FOR CODE GENERATION USING VOICE AND VIRTUAL REALITY

(71) Applicant: CA, Inc., New York, NY (US)

(72) Inventors: Praveen CHAVALI, Hyderabad (IN); Sunil MEHER, Hyderabad (IN); Vallinayagam PITCHAIMANI, Hyderabad (IN); Bidyapati PRADHAN, Hyderabad (IN)

(73) Assignee: CA, Inc., New York, NY (US)

(21) Appl. No.: 15/469,770

(22) Filed: Mar. 27, 2017

(51) Int. Cl. G06F 3/16; G10L 15/26; G06F 3/01; G06F 17/27; G06F 17/28; G10L 15/06; G10L 15/18; G06F 17/30

(52) U.S. Cl. CPC G06F 3/167; G10L 15/265; G06F 3/011; G06F 17/2705; G06F 17/28; G06F 2203/0381; G10L 15/06; G10L 15/1822; G06F 17/30761; G06F 17/3043; G06F 3/017

(57) ABSTRACT

A method includes processing voice audio input by a user to extract a general programming instruction and determining a context of the general programming instruction based on a detected gesture (1) made by the user with respect to a display interface and (2) associated with the voice audio input by the user. The method also includes outputting an appropriate source code instruction in a programming application being displayed on the display interface based on the general programming instructions and the context.

### BACKGROUND

The present disclosure relates to coding, and, more specifically, to systems and methods for generating code using natural language audio input and virtual reality context input.

Computer programming is a process that leads for an original formulation of a computer problem to executable computer programs. Programming involves analysis, developing understanding, generating algorithms, verification of resource consumption, and coding to implement the programming solution. Source code may be written in one or more programming languages and is often written in a team effort. The purpose of programming is to find a sequence of instructions that will automate performing a specific task or solving a given problem. The process of programming often requires expertise in many different subjects, including knowledge of the application domain, specialized algorithms, and formal logic.

Every website, smartphone app, computer program, calculator, and electronic device relies on code to operate. Essentially, code powers our digital world. Developers spend the majority of their time focusing on syntax and typing out commands for the code, as well as determining whether the code runs as intended.

However, current coding technology is often cumbersome and requires developers to spend the majority of their time focusing on syntax and typing. Furthermore, developers are required to learn different coding languages and think in bits and pieces of code instead of broader functionality. Systems and methods described herein may apply a combination of natural language processing, machine learning, and virtual reality functionality to streamline the developer experience.

Systems and methods described herein may process audio input comprising natural language, the audio input indicating a particular code template of a plurality of code templates from a code template database associated with a coding environment. Systems and methods described herein may process context input from a virtual reality device, the context input indicating a location in the coding environment to enter the particular code template indicated by the audio input. Systems and methods described herein may generate a line of code by inserting the particular code template at the location in the coding environment.

### BRIEF SUMMARY

According to an aspect of the present disclosure, a method includes processing voice audio input by a user to extract a general programming instruction. The method also includes determining a context of the general programming instruction based on a detected gesture (1) made by the user with respect to a display interface and (2) associated with the voice audio input by the user. The method further includes outputting an appropriate source code instruction in a programming application being displayed on the display interface based on the general programming instructions and the context.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of a code generator ecosystem in a non-limiting embodiment of the present disclosure.

FIG. 2 is a schematic representation of a code generator configured to interact with the code generator ecosystem.

FIG. 3 illustrates functionality of a code generator according to a non-limiting embodiment of the present disclosure.

FIG. 4 is a data flow diagram in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to delivery systems, systems and methods disclosed herein may be related to any field involving correspondence or communication. Moreover, certain examples disclosed herein may be described with respect to consumer or business solutions, or any other field that may involve communication. Certain embodiments described in the present disclosure are merely provided as example implementations of the processes described herein.

The teachings of the present disclosure may reference specific example “device.” For example, a “device” may refer to a smartphone, tablet, desktop computer, laptop, Global Positioning System (GPS) device, satellite communication terminal, radio communication terminal, or any other device capable of communications. For example, a mobile device may be equipped with an application capable of communicating with an email system. Any device with such capabilities is contemplated within the scope of the present disclosure.

In a first example, systems and methods disclosed herein may process, using one or more processors, audio input comprising natural language, the audio input indicating a particular code template of a plurality of code templates from a code template database associated with a coding environment. Systems and methods disclosed herein may process, using one or more processors, context input from a virtual reality device, the context input indicating a location in the coding environment to enter the particular code template indicated by the audio input. Further, systems and methods disclosed herein may generate, using one or more processors, a line of code by inserting the particular code template at the location in the coding environment. In certain embodiments, additional code elements may be inserted, modified, or deleted. For example, multiple lines of code, a function/method, class, interface, or the like may be inserted. Those of ordinary skill in the art will appreciate that reference to inserting a line of code as used herein may refer to insertion or addition of multiple lines of code or entire classes or programming structures.

In a second example, systems and methods disclosed herein may process audio input comprising natural language, the audio input indicating a particular code template of a plurality of code templates from a code template database associated with a coding environment, wherein the coding environment is an integrated development environment. Systems and methods disclosed herein may process context input from a virtual reality device, the context input indicating a location in the coding environment to enter the particular code template indicated by the audio input. Systems and methods disclosed herein may generate, using one or more processors, a line of code by inserting the particular code template at the location in the coding environment. As another example, multiple lines of code may be inserted.

In a third example, systems and methods disclosed herein may process audio input comprising natural language, the audio input indicating a particular code template of a plurality of code templates from a code template database associated with a coding environment. Systems and methods disclosed herein may process context input from a virtual reality device, the context input indicating a location within the coding environment to enter the particular code template indicated by the audio input. Systems and methods disclosed herein may generate, using one or more processors, a line of code by inserting the particular code template at the location in the coding environment. Systems and methods disclosed herein may process comment context input from the virtual reality device, the comment context input indicating a comment location within the coding environment, the comment location in proximity to the location indicated by the context input. Systems and methods disclosed herein may process audio comment input comprising a comment in natural language, and generate a code comment by inserting the comment at the comment location in the coding environment.

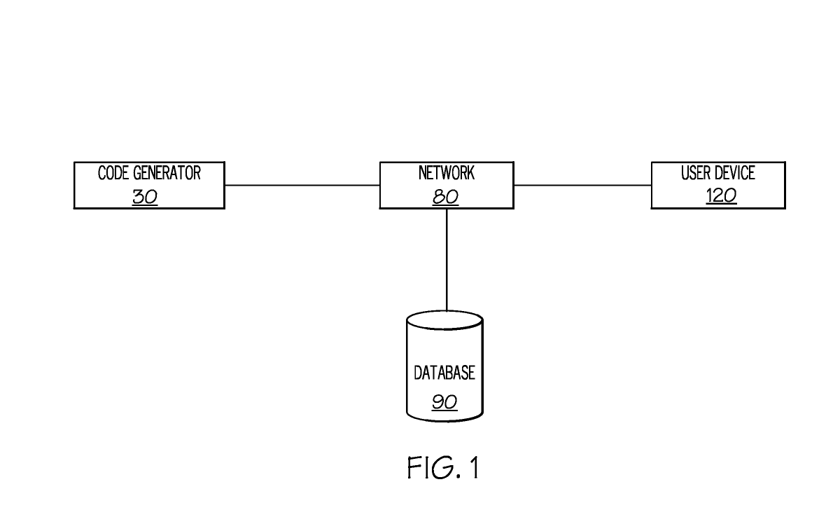

FIG. 1 is a schematic representation of a code generator ecosystem in a non-limiting embodiment of the present disclosure. A code generator 30 may communicate with a database 90 and user device 120 via a network 80. In some non-limiting embodiments of the present disclosure, code generator 30 may directly communicate with user device 120 if code generator 30 is installed on the user device 120. Further, code generator 30 may communicate with a local database 95. User device 120 may be a mobile device capable of communicating with code generator 30. In some non-limiting embodiments, code generator 30 may be installed on the user device 120 as, for example, a plug-in. In some non-limiting embodiments, code generator 30 may be a plug-in for an email application or a mobile application on a user's mobile device.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be any type of computer such as, for example, a desktop computer. In other non-limiting embodiments, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host email applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In some non-limiting embodiments code generator 30 may use network 80 to communicate with user device 120. In other non-limiting embodiments of the present disclosure, code generator 30 may be installed on the user device 120. Code generator 30 may be fully installed on the user device 120 and work in tandem with resources located on the cloud or within network 80. In some non-limiting embodiments of the present disclosure, code generator 30 may support communications between the user device 120 and another device. In some non-limiting embodiments, user device 120 may represent a plurality of user devices such as, for example, laptops and mobile cellular telephones. In addition, a user may access code generator 30 from the plurality of devices via network 80.

The code generator 30 environment may also include a database 90. Database 90 may include, for example, additional servers, data storage, and resources. Code generator 30 may receive from database 90 additional data, coding templates, coding support resources, user account information, user correspondence history and preferences, coding information, or any data used by code generator 30. Database 90 may be any conventional database or data infrastructure. For example, database 90 may include scaled out data architectures (i.e., Apache Hadoop) and/or persistent, immutable stores/logging systems. Database 90 may store a plurality of code templates for a plurality of coding languages.

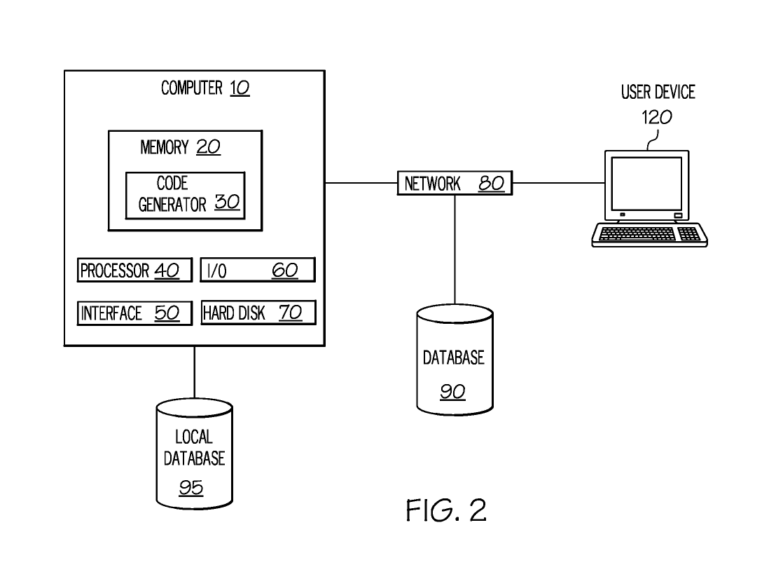

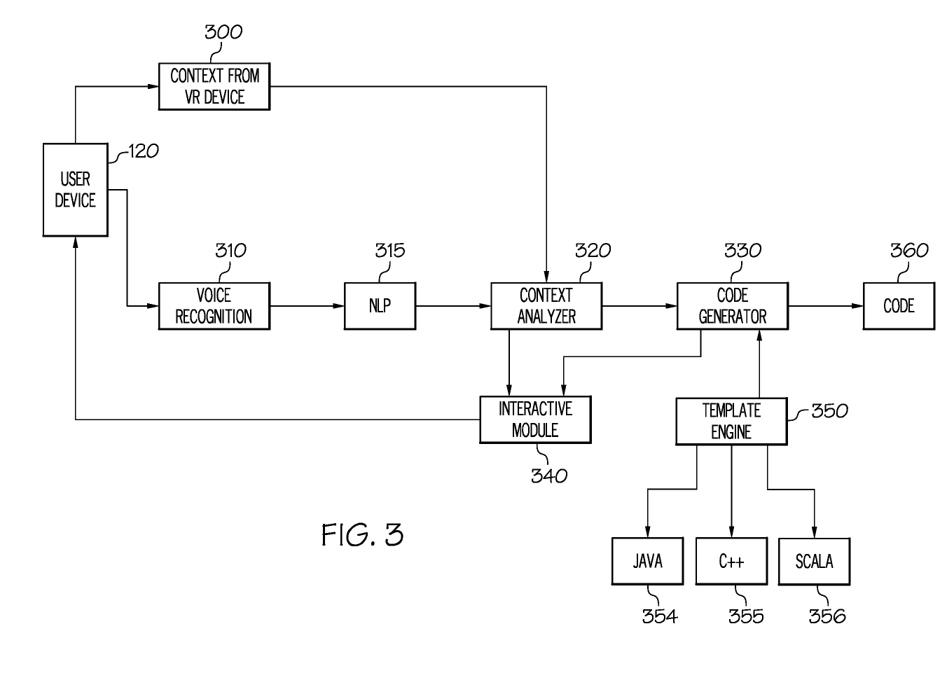

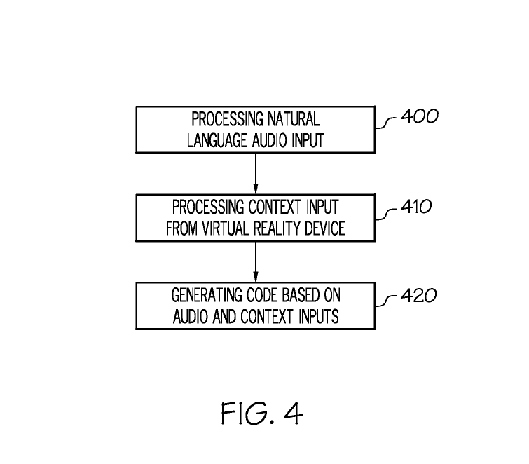

FIG. 2 displays the code generator 30 of a non-limiting embodiment of the present disclosure. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct computer 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU or code generator 30 to perform a plurality of functions. Examples of such functions are described below with respect to FIGS. 3-4.

In some non-limiting embodiments of the present disclosure, the CPU may be code generator 30. In some implementations, when computer-readable instructions, such as an application program or a script, are executed by the CPU, the computer-readable instructions stored in memory 20 may instruct the code generator 30 to interact with user device 120. Computer 10 may be located on the user device 120, on a remote server, on the cloud, or any combination thereof. In some non-limiting embodiments, Computer 10 and code generator 30 may communicate with user device 120 via network 80. In some non-limiting embodiments, code generator 30 may interact with an email application on the computer 10 to communicate with other devices, such as user device 120. In some non-limiting embodiments, code generator 30 may be located on the user device 120.

I/O device 60 may receive data from network 80, database 90, local database 95, data from other devices and sensors connected to code generator 30, and input from a user and provide such information to the code generator 30. I/O device 60 may transmit data to network 80, database 90, and/or local database 95. I/O device 60 may transmit data to other devices connected to code generator 30, and may transmit information to a user (e.g., display the information, send an e-mail, make a sound) or transmit information formatted for display on a user device 120 or any other device associated with the user. Further, I/O device 60 may implement one or more of wireless and wired communication between user device 120 or code generator 30 and other devices within or external to network 80. I/O device 60 may receive one or more of data from another server or a network 80. The code generator 30 may be a processing system, a server, a plurality of servers, or any combination thereof. In addition, I/O device 60 may communicate received input or data from user device 120 to code generator 30.

Code generator 30 may be located on the cloud, on an external network, on user device 120, or any combination thereof. Code generator 30 may be SaaS or entirely located on the user device 120. Furthermore, some non-limiting configurations of code generator 30 may be located exclusively on a user device 120, such as, for example, a mobile device or tablet. Code generator 30 may also be accessed and configured by a user on user device 120 or any other graphical user interface with access to code generator 30. In some non-limiting embodiments, the user may connect to network 80 to access code generator 30 using the user device 120.

Further referring to FIG. 2, in some non-limiting embodiments of the present disclosure, a mobile application may be installed on the user device 120. The mobile application may facilitate communication with code generator 30, database 90, local database 95, an email application on user device 120, or any other entity. In some non-limiting embodiments, a program on user device 120 may track, record, and report input information to the code generator 30, such as, for example, past interactions, login dates and times, code generations and corresponding edits, user configurations, and corresponding data.

In some non-limiting embodiments, user device 120 may store data, user preferences and configurations, and any other data associated with the code generator 30 locally on the user device 120. In some non-limiting embodiments of the present disclosure, an application on the user device 120 may communicate with code generator 30 to manage communications, data, and corresponding user input or requests on the user device 120. User device 120 may have a user interface for the user to communicate with code generator 30. An application on the user device 120 and code generator 30 may maintain an offline copy of all information. In some non-limiting embodiments of the present disclosure, in which the code generator 30 is located partially or completely on user device 120, code generator 30 may facilitate communications regarding communications with other devices. Code generator 30 may also facilitate communications between users via SMS protocol, messaging applications on any device, or any other application used for communication. Code generator 30 may rely on information stored locally on user device 120. User may store communication preferences, such as a preferred delivery information and signal data, on the user device 120. In some systems and methods of the present disclosure, code generator 30 may rely on information such as user preferences and configurations in a cloud database.

FIG. 3 illustrates functionality of a code generator according to a non-limiting embodiment of the present disclosure. A developer may use a user device 120 to draft code for a project. Voice recognition 310 may receive audio input via natural spoken language into the user device 120. A natural language processor (NLP) 315 may process the received spoken language and generate computer output representing the spoken language. In some non-limiting embodiments, the audio input via natural spoken language may indicate a particular code template of a plurality of code templates from a code template database associated with a coding environment. Further, in some non-limiting embodiments, the spoken language does not include any code syntax. Instead, developers may speak naturally regarding the intended logical functional purpose of the intended code.

In addition, the developer may have a user device 120 with virtual reality (VR) capabilities. In such cases, the developer may produce context input using the VR functionality, wherein the context input may indicate a location in the coding environment to enter code. In some non-limiting embodiments, developers may view and navigate a coding environment in a virtual world using such capabilities. In some non-limiting embodiments, a user utilizing user device 120 may control a cursor using the VR functionality. In such embodiments, a user may select, highlight, and perform all functions similar to using a mouse with a desktop computer. In some embodiments, a user device 120 with VR capabilities may include additional hardware for control within the virtual environment.

Context analyzer 320 may receive audio input processed by the NLP 315 as well as context input from a user device 120 enabled for virtual reality. Context analyzer 320 may forward data to the code generator 330, which may rely on a template engine 350 to determine whether the audio input indicates a particular code template of a plurality of code templates from a code template database associated with the coding environment. In some non-limiting embodiments, the code template database may categorize the plurality of code templates according to industry (e.g., healthcare, insurance, finance, etc.). Context analyzer 320 and code generator 330 may determine whether context input from a virtual reality enabled device indicates a location in the coding environment to enter the particular code template indicated by the audio input. Upon determining the location of an indicated code template, code generator 330 may generate a line of code 360 by inserting the code template at the location within the coding environment. Template engine 350 may include a plurality of different computing languages, including Java 354, C++ 355, and Scala 356.

Interactive module 340 may be accessible on any type of device. A user may utilize interactive module 340 to edit or correct actions of context analyzer 320 and code generator 330. For example, if the audio input was intended to indicate a different code template than the one determined by the context analyzer 320 and code generator 330, a user may correct the line of code accordingly using the interactive module 340. Similarly, if the code template is as intended but the placement location of the code template is inaccurate, a user may adjust the location within the coding environment using the interactive module 340. The interactive module 340 may receive input via keyboard, voice, mouse, sensors, cameras, or any other type of communicative input. In certain embodiments, the interactive module may interpret ambiguous input provided by the user. For example, if the analyzer is unable to match an input with a template or code generation input, the interactive module may request additional information from the user in order to better select an input for insertion in the code.

FIG. 4 is a data flow diagram provided in accordance with a non-limiting embodiment of the present disclosure. In step 400, code generator 30 may process natural language audio input. Code generator 30 may use a natural language processor to determine whether the audio input indicates a particular code template of a plurality of code templates from a code template database associated with a coding environment.

Code generator 30 may also process context input from a virtual reality device, as shown in step 410. The virtual reality device may be the same device or a different device as user device 120. Code generator 30 may determine whether the context input from the virtual reality device indicates a location in the coding environment to enter the particular code template indicated by the audio input.

Code generator 30 may also generate code based on the audio and contextual inputs. Code generator 30 may generate a line of code by inserting the particular code template indicated by the audio input at the location in the coding environment indicated by the contextual input. Code generator 30 may also track and store data regarding user communications. For example, code generator 30 may track and store communications with a plurality of user devices as well as location profiles, code data, and any other input data. In some non-limiting embodiments, code generator 30 may register a plurality of user devices for a single user account. Code generator 30 may communicate with a user on any of the user devices associated with the user account. Data may be stored on local database 95, database 90, on computer 10, on user device 120, in the cloud, or in any other manner.

After generating the code, or at any time during the development process, code generator 30 may receive additional input from a keyboard or mouse device. A user may also edit or add code using any input methods for a computer. For example, a user may use a keyboard to edit the particular code template generated in the coding environment. Upon receiving an edit to a line of code (e.g., via keyboard, voice input, etc.), code generator 30 may also manipulate the code template in the database to mirror the manipulation of the line of code. As such, code generator 30 may exhibit machine learning capabilities. In addition, users may add code templates to the database as needed.

In some non-limiting embodiments, code generator 30 may receive comment input from a user device 120 via voice command or keyboard. Code generator 30 may also receive comment context input from the virtual reality device, wherein the comment context input indicates a comment location in the coding environment. In some non-limiting embodiments, the comment location is in proximity to the location of the particular code template indicated by the context input. Code generator 30 may generate a code comment by inserting the comment at the comment location in the coding environment. In some non-limiting embodiments, the coding environment may be an integrated development environment. Further, the integrated development environment may be accessible from a plurality of mobile devices and from a plurality of locations.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

1. A method comprising:
processing, by one or more processors, voice audio input by a user to extract a general programming instruction;
determining, by the one or more processors, a context of the general programming instruction based on a detected gesture (1) made by the user indicating an input location in a programming application displayed in a display interface and (2) associated with the voice audio input by the user;
determining an appropriate source code instruction based on the general programming instruction and the context that matches a programming language used in the programming application and a syntax of the input location; and
outputting the appropriate source code instruction in the programming application.

2. The method of claim 1,
wherein the voice audio input comprises natural language that is processed by a natural language parser to identify a particular code template of a plurality of code templates, and
wherein the voice audio input is further processed to identify values for insertion into the particular code template to create the general programming instruction.

3. The method of claim 1, wherein the appropriate source code instruction is determined by translating the general programming instruction into a programming language associated with the programming application.

4. The method of claim 1, further comprising outputting the general programming instruction for editing by the user.

5. The method of claim 1, wherein the gesture is input using a virtual reality device.

6. The method of claim 1,
wherein the voice audio is determined to be a code comment, and
wherein the code comment is output with respect to a displayed programming instruction based on the context.

7. The method of claim 1, wherein the programming application is an instance of an integrated development environment.

8. The method of claim 1, wherein the programming application is a particular one of a plurality of programming applications being displayed on the display interface.

9. The method of claim 8,
wherein the plurality of programming applications are each associated with a different programming language, and
wherein the appropriate source code instruction is suitable for a syntax of the associated programming language for the particular one of the plurality of programming applications being displayed on the display interface.

10. The method of claim 1, wherein the appropriate source code instruction is selected from a database comprising instructions in a plurality of coding languages that correspond to the general programming instruction.

11. A computer configured to access a storage device, the computer comprising:
a processor; and
a non-transitory, computer-readable storage medium storing computer-readable instructions that when executed by the processor cause the computer to perform:
processing voice audio input by a user to extract a general programming instruction;
determining a context of the general programming instruction based on a detected gesture (1) made by the user indicating an input location in a programming application displayed in a display interface and (2) associated with the voice audio input by the user;
determining an appropriate source code instruction based on the general programming instruction and the context that matches a programming language used in the programming application and a syntax of the input location; and
outputting the appropriate source code instruction in the programming application.

12. The computer of claim 11,
wherein the voice audio input comprises natural language that is processed by a natural language parser to identify a particular code template of a plurality of code templates, and
wherein the voice audio input is further processed to identify values for insertion into the particular code template to create the general programming instruction.

13. The computer of claim 11, wherein the appropriate source code instruction is determined by translating the general programming instruction into a programming language associated with the programming application.

14. The computer of claim 11, further comprising outputting the general programming instruction for editing by the user.

15. The computer of claim 11, wherein the gesture is input using a virtual reality device.

16. The computer of claim 11,
wherein the voice audio is determined to be a code comment, and
wherein the code comment is output with respect to a displayed programming instruction based on the context.

17. The computer of claim 11, wherein the programming application is an instance of an integrated development environment.

18. The computer of claim 11, wherein the programming application is a particular one of a plurality of programming applications being displayed on the display interface.

19. The computer of claim 18,
wherein the plurality of programming applications are each associated with a different programming language, and
wherein the appropriate source code instruction is suitable for a syntax of the associated programming language for the particular one of the plurality of programming applications being displayed on the display interface.

20. A non-transitory computer-readable medium having instructions stored thereon that are executable by a computing system to perform operations comprising:
processing voice audio input by a user to extract a general programming instruction;
determining a context of the general programming instruction based on a detected gesture (1) made by the user indicating an input location in a programming application displayed in a display interface and (2) associated with the voice audio input by the user;
determining an appropriate source code instruction based on the general programming instruction and the context that matches a programming language used in the programming application and a syntax of the input location; and
outputting the appropriate source code instruction in the programming application.
